(19) United States
(12) Patent Application Publication
(10) Pub. No.: US 2012/0039207 A1
(43) Pub. Date: Feb. 16, 2012

(54) Link Adaptation with Aging of CQI Feedback Based on Channel Variability

(75) Inventors: Erik Eriksson, Linkoping (SE); Yu Qian, Beijing (CN); Arne Simonsson, Gammelstad (SE)

(73) Assignee: TELEFONAKTIEBOLAGET LM ERICSSON (PUBL), Stockholm (SE)

(21) Appl. No.: 13/264,104

(22) PCT Filed: Apr. 14, 2009
(86) PCT No.: PCT/SE09/50383

§ 371 Date: Oct. 12, 2011

(51) Int. Cl. H04W 72/08; H04W 24/00

(52) U.S. Cl. 370/252

(57) ABSTRACT

According to teachings presented in this document, reported channel quality information, as used for controlling one or more aspects of wireless transmission, is compensated according to an aging function that depends on channel variability. In this manner, the “amount” or extent of age-based compensation applied to the channel quality feedback for a given user—e.g., a mobile station or other item of user equipment—varies as function of that user's channel conditions. More particularly, in an advantageous approach, the aging function applied to the channel quality estimates received from a given user depends on estimates of that user's channel variability. Channel quality estimates from (or generated for) a user whose channel conditions are changing very little, or at least are changing very slowly, may be aged less aggressively than those associated with a user whose channel conditions are changing more rapidly.

### TECHNICAL FIELD

The present invention generally relates to wireless communication link adaptation, and particularly relates to aging the channel quality information used for adaptation according to channel variability.

### BACKGROUND

In a common approach to link adaptation for wireless communications, the transmitter adjusts one or more transmission parameters responsive to changes in the receivers channel quality. The receiver supports link adaptation by the transmitter by sending channel quality information as feedback to the transmitter. For example, the receiver periodically measures channel quality and sends corresponding Channel Quality Indicators (CQIs) to the transmitter, which uses the reported CQIs to adjust the modulation and coding scheme used for transmitting to the receiver.

Ongoing signal quality measurements at the receiver drive CQI generation and feedback. For example, the receiver periodically measures received signal quality as a signal-to-noise ratio (SNR), and maps the measured SNRs into a defined table of CQI values, each value representing a range of SNRs in dBs. CQI may be expressed in terms of transport format sizes which approximately follow an SNR dB scale. Here, the receiver estimates the largest transport format that can be received at a defined reliability or other performance metric. In such embodiments, the CQI values quantize measured SNR and provide a more compact signaling format, which is desirable for high CQI reporting rates. Of course, CQIs can be based on measures other than an SNR scale. Regardless, higher CQI reporting rates are used in more sophisticated wireless communication networks to drive fast dynamic scheduling and link adaptation, which allows those systems to achieve high bit rates and high system throughput.

High Speed Data Packet Access (HSDPA) services in Wideband CDMA, for example, rely on high CQI reporting rates. Long Term Evolution (LTE) networks also rely on high CQI reporting rates to support the fast user scheduling and link adaptation used in such networks to maintain high utilization of the communication link—i.e., to maintain high aggregate data throughput on the link. Even with fast CQI reporting, problems remain. For example, there is an “aging” problem associated with the delay between the time a receiver measures its signal quality and the time that the correspondingly transmitted CQI is actually used at the transmitter for adapting the link with respect to that receiver. The age of a given CQI value includes delays between the receiver measuring and reporting signal quality, transmission link delays, and the delay between the transmitter receiving the CQI and using it for link adaptation. That last delay may include scheduling delays, where the transmitter schedules its downlink transmissions to different users.

In HSDPA, such reporting delays are in the range of six milliseconds. That value in combination with a reporting period of eight milliseconds results in an overall delay that varies between eight and fourteen milliseconds. This magnitude of overall delay is tolerable, in terms of maintaining a desired tradeoff between latency and link throughput. That is, it is desirable to send data at the highest rate possible, while limiting the need for retransmissions. HSDPA targets a given Block Error Rate (BLER) at the receiver, e.g., a 10% BLER, and uses Hybrid Automatic Repeat Request (HARQ) for retransmitting data as needed.

Even so, it is known in the art to mitigate the “aging” problem. For example, U.S. Pub. 2005/0181811 A1 teaches “correcting” CQI feedback from a receiver according to an “offset” value. As this reference explains, a channel-dependent scheduler at a base station schedules the user or users reporting the best channel conditions, but the actual channel qualities for those users may have deteriorated by the time the scheduled transmissions occur. The reference thus looks at additional information that can be used to get a more accurate sense of channel quality. In one embodiment, ACK/NACK feedback from a receiver provides a basis for determining or otherwise updating an offset value that is used to correct CQI feedback from the receiver. In this manner, CQIs reported by the receiver can be discounted or otherwise reduced by a performance-based offset that is determined by monitoring one or more parameters indicative of reception performance. The approach is useful in that it helps prevent the selection of overly optimistic transmission parameter settings.

Another known mitigation technique applies a similar type of offset to reported CQIs, but bases the offset on CQI age. The published patent application WO 2006/075208 A1 provides an example of age-based CQI compensation in the HSDPA context. The '208 reference suggests that applying corrective back-off or offset values to all CQIs is less preferable than applying an age-dependent offset, in the sense that a relatively new CQI may well provide an accurate sense of current channel conditions at the reporting receiver. As such, the '208 reference teaches applying an offset to reported CQIs, where the magnitude of the applied offset is determined as a function of CQI age.

Neither of the above approaches directly addresses the challenges posed by some of the newer communication network standards, such as Long Term Evolution (LTE). Like HSDPA and other high-rate services, LTE relies on fast link adaptation and dynamic user scheduling, to achieve high bit rates and maintain high data throughput. For example, an LTE base station, referred to as an eNodeB, may perform link adaptations on a one millisecond basis. LTE receivers support such operations by generating periodic CQI reports according to measurements taken from common reference symbols received in the downlink. The receivers send CQI reports on a physical uplink control channel (the PUCCH, for example), and also may send CQI reports on a physical uplink shared channel (the PUSCH, for example), responsive to receiving grants from an eNodeB.

Problematically, however, certain modes of operation in LTE can result in significantly extended delays between CQI reports from a given user, as compared to HSDPA, for example. In the current LTE standards, the reporting delays for CQIs may be as short as four milliseconds, and as long as eighty milliseconds. Such variability significantly complicates any approach to CQI correction, as there may not be enough recent feedback for performance-based back-offs. Further, with the wide variability in reporting delays and the potential for very long reporting delays, the known approaches to age-based back-offs may produce overly conservative back-offs, which lowers data throughput below achievable levels and thus wastes link capacity.

### SUMMARY

According to teachings presented in this document, reported channel quality information, as used for controlling one or more aspects of wireless transmission, is compensated according to an aging function that depends on channel variability. In this manner, the “amount” or extent of age-based compensation applied to the channel quality feedback for a given user—e.g., a mobile station or other item of user equipment—varies as a function of that user's channel conditions. More particularly, in an advantageous approach, the aging function applied to the channel quality estimates received from (or generated for) a given user depends on estimates of that user's channel variability. Channel quality estimates for a user whose channel conditions are changing very little, or at least are changing very slowly, may be aged less aggressively than those associated with a user whose channel conditions are changing more rapidly.

Compensating, or otherwise adjusting a given channel quality estimate comprises, in one or more embodiments, applying a back-off value to the channel quality estimate. For example, a back-off amount may be subtracted from a given channel quality estimate, where the magnitude of the back-off amount is a function of the age of the channel quality estimate, and of the variability in channel quality. The amount of back-off can be linearly or non-linearly related to variability in channel quality, but, as a general proposition, for a given age of channel quality estimate, more back-off is applied for higher variability in channel quality, and less back-off is applied for lower variability in channel quality.

With these teachings in mind, one embodiment of a method of computing aged channel quality estimates for use in controlling transmissions on a wireless communication link includes estimating a variability in channel quality for the wireless communication link, and computing aged channel quality estimates corresponding to channel quality estimates determined for the wireless communication link. The channel quality estimates may be determined on an “ongoing” basis, which may be a periodic basis, and/or an as-needed basis, such as for scheduled transmissions. In any case, the aged channel quality estimates are computed by adjusting the value of each channel quality estimate by an amount that depends on the age of the channel quality estimate and on the variability in channel quality estimated for the wireless communication link. Channel quality estimates are, for example, Channel Quality Indicator (CQI) values received from or generated for a remote transceiver.

In another embodiment, a wireless communication transceiver is configured to compute aged channel quality estimates for use in controlling transmissions on a wireless communication link. Advantageously, the wireless communication transceiver includes one or more processing circuits configured to estimate a variability in channel quality for the wireless communication link, and compute aged channel quality estimates corresponding to channel quality estimates determined for the wireless communication link. The wireless communication transceiver computes the aged channel quality estimates by adjusting the value of each channel quality estimate by an amount that depends on the age of the channel quality estimate and on the variability in channel quality estimated for the wireless communication link.

In one such embodiment, the wireless communication transceiver comprises a base station in a wireless communication network, and the wireless communication link comprises downlinks between the base station and a plurality of mobile terminals. As such, the base station determines (or receives) aged channel quality estimates for each mobile terminal and controls downlink transmissions to the mobile terminals based on the aged channel quality estimates. Similarly, in another embodiment, the wireless communication link comprises uplinks between a base station in a wireless communication network, and a plurality of mobile terminals. In at least one such embodiment, the base station estimates channel quality for each mobile terminal based on received uplink signals, and correspondingly generates aged channel quality estimates for each mobile terminal. Further, the base station controls uplink transmissions by the mobile terminals, based on the aged channel quality estimates. For example, the base station determines uplink scheduling decisions for the mobile terminals based on their aged channel estimates.

In another embodiment, a method of controlling transmissions from a wireless communication network base station to mobile terminals is based on aged channel quality estimates, e.g., aged channel quality indicators. The method includes receiving channel quality indicators from each of one or more mobile terminals, for use in controlling transmissions to the one or more mobile terminals. In particular, the method includes estimating a variability in channel quality for each mobile terminal, and computing aged channel quality indicators for each mobile terminal by adjusting the channel quality indicators received from the mobile terminal according to an aging function that depends on channel quality indicator age and on the variability in channel quality estimated for the mobile terminal. The method further includes controlling transmissions to the one or more mobile terminals based on the aged channel quality indicators.

Similarly, in another disclosed embodiment, a wireless communication network base station is configured to control transmissions to a plurality of mobile terminals based at least in part on receiving channel quality indicators from the mobile terminals. Advantageously, the base station includes one or more processing circuits configured to estimate a variability in channel quality for each mobile terminal, and compute aged channel quality indicators for the mobile terminals. The processing circuits compute these aged channel quality indicators by adjusting the channel quality indicators received from each mobile terminal according to an aging function that depends on channel quality indicator age and on the variability in channel quality estimated for the mobile terminal. Further, the processing circuits control transmissions to the mobile terminals based on the aged channel quality indicators.

Of course, the present invention is not limited to the above brief summary of features and advantages. Those skilled in the art will recognize additional features and advantages upon reading the following detailed description and upon viewing the accompanying figures.

### BRIEF DESCRIPTION OF THE DRAWINGS

FIG. 1 is a block diagram of first and second wireless communication transceivers, where one or both of the transceivers is configured to compute aged channel quality estimates as a function of variability in channel quality.

FIG. 2 is a partial block diagram of one embodiment of a wireless communication network, including a base station configured to control transmissions to mobile terminals, based on aging channel quality reports from those mobile terminals according to corresponding estimates of channel quality variability.

FIG. 3 is a block diagram of an embodiment of one or more processing circuits configured to generate aged channel quality information, e.g., aged Channel Quality Indicators (CQIs).

FIG. 4 is a logic flow diagram of one embodiment of a method for generating aged channel quality information, and controlling transmissions based on the aged information.

FIGS. 5 and 6 are plots of example aging functions, e.g., families of predefined aging curves, that can be used to make the amount of aging applied to given channel quality information functionally dependent on an estimated variability in channel quality.

FIGS. 7 and 8 are diagrams of embodiments of a memory circuit or circuits, which are configured to store predefined aging functions and/or look-up tables (LUTs) corresponding to predefined aging functions.

FIG. 9 is a block diagram of one embodiment of a CQI aging processor that is configured to control the amount of aging-based back-off applied to CQIs incoming from given mobile terminals, based on estimating channel quality variability for those terminals using correlation processing.

FIG. 10 is a partial block diagram of one embodiment of a wireless communication network, wherein different default values of estimated channel quality variability are used in different network cells or sectors.

### DETAILED DESCRIPTION

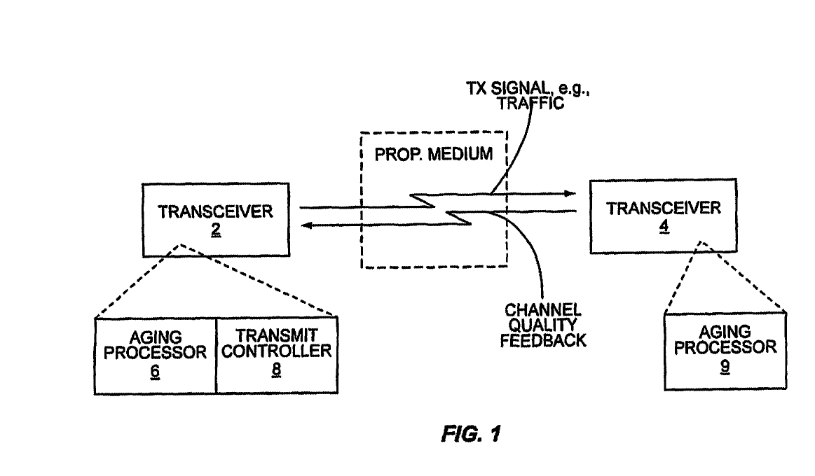

FIG. 1 illustrates first and second wireless communication transceivers 2 and 4. In one embodiment, the first transceiver 2 transmits to the second transceiver 4 and correspondingly receives channel quality feedback from the second transceiver. Further, the first transceiver 2 estimates the variability in channel quality for the wireless communication link to the second transceiver 4, and computes aged channel quality estimates for the second transceiver 4, based on ages of the channel quality estimates received from the second transceiver 4, and on the variability in channel quality estimated for the second transceiver 4. That is, the first transceiver 2 estimates a variability in channel quality for the wireless communication link between it and the second transceiver 4, and computes aged channel quality estimates corresponding to channel quality estimates determined for the wireless communication link. Particularly, in one or more embodiments, the wireless communication transceiver 2 computes aged channel quality estimates by adjusting the value of each channel quality estimate by an amount that depends on the age of the channel quality estimate and on the variability in channel quality estimated for the wireless communication link.

As such, one or more embodiments of the first transceiver 2 includes one or more processing circuits for computing aged channel quality estimates, e.g., an “aging” processor 6, and, in a general case, the first transceiver 2 further includes a transmit controller 8 that is configured to control transmissions to the second transceiver 4, based at least in part on the aged channel quality estimates computed for the second transceiver 4. Alternatively, the second transceiver 4 computes the aged channel quality estimates and returns them to the first transceiver 2. In such embodiments, the second transceiver 4 may include its own aging processor 9, which may be configured to determine actual ages for the channel quality estimates it is generating, based on knowledge of transmission scheduling at the first transceiver 2, or it may determine an average age based on past transmission timing.

In one or more embodiments, the wireless communication transceiver 2 comprises a base station in a wireless communication network and the wireless communication link comprises downlinks between the base station and a plurality of mobile terminals. Here, it should be understood that the wireless transceiver 4 represents an example of one such mobile terminal. Advantageously, the base station is configured to control downlink transmissions to each mobile terminal based on the aged channel quality estimates computed for each mobile terminal. In at least one such embodiment, the base station is configured to receive channel quality estimates from each mobile terminal on an ongoing basis, and correspondingly compute the aged channel quality estimates for that mobile terminal. Alternatively, the base station may receive aged channel quality estimates as computed by each mobile terminal.

In any case, in at least one embodiment, the base station is configured to control downlink transmissions to the mobile terminals based on the aged channel quality estimates by one or more of selecting modulation and coding schemes, selecting transmission rank, selecting between open-loop or closed-loop multiple-input-multiple-output transmission modes, selecting between wideband and frequency selective transmission precoding, selecting between transmit diversity and spatial multiplexing, and scheduling transmissions to the mobile terminals, based at least in part of the aged channel quality estimates.

In another embodiment, the wireless communication link between the first and second transceiver 2 and 4 comprises uplinks between a base station (the first transceiver 2) and a plurality of mobile terminals (the second transceiver 4 represents an example of one such mobile terminal). Advantageously, in such embodiments, the base station is configured to control uplink transmissions from the mobile terminals based on the aged channel quality estimates computed for the mobile terminals. For example, for each mobile terminal, the base station is configured to compute channel quality estimates based on uplink signals received from the mobile terminal, and correspondingly compute the aged channel quality estimates for that mobile terminal.

In another embodiment, the base station is configured to use a default value for the estimated variability in channel quality for each mobile terminal, at least during an initialization period, where the default value is based on a known or expected variability in channel quality that is characteristic for at least one of a given time of day and a given service area of the wireless communication network that is associated with the base station. That is, the characteristic variability in channel quality may be different for different service areas and, even within a given service area, it may be different at different times of the day.

In another embodiment, the base station is configured for different modes of Multiple-Input-Multiple-Output, MIMO, transmissions to a plurality of mobile terminals, and is configured to associate different MIMO modes with different predefined values or degrees of variability in channel quality. As such, the base station estimates the variability in channel quality for each mobile terminal at least in part on a current communication mode of the mobile terminal.

Further, returning to the details of FIG. 1, the first transceiver 2 is, in one or more embodiments, configured to compute the aged channel quality estimates by, for a given channel quality estimate, selecting a particular aging function from among a predefined set of aging functions, and determining an adjustment value for the channel quality estimate according to the age of the channel quality estimate and the selected aging function. In at least one such embodiment, the first transceiver 2 is configured to store parameterized functional expressions or tabulated look-up values representing the predefined set of aging functions.

In these and other embodiments, the first transceiver 2 is configured to determine the age of a given channel quality estimate based on calculating an elapsed time between a corresponding channel quality measurement on which the channel quality estimate is based and a forthcoming transmission time in which the corresponding aged channel quality estimate will be used for controlling transmission on the wireless communication link. For example, the age may be calculated based on the total time between the second transceiver 4 measuring channel quality and generating a corresponding channel estimate, and the first transceiver 2 making a transmit control adjustment according to that channel quality estimate. All or part of this elapsed time may be known or determined, or one or more components of the elapsed time may be based on assumed values.

In at least one embodiment, the first transceiver 2 is configured to estimate the variability in channel quality for the wireless communication link by correlating the channel quality estimates over time. In the context of this approach, higher correlation values indicate lower variability in channel quality and lower correlation values indicate higher variability in channel quality. If multiple links are involved, e.g., if channel quality estimate aging is being performed for multiple mobile terminals being supported by the base station, each mobile terminal's channel quality estimates are correlated, for determining the variability in channel quality for that particular mobile terminal.

In another embodiment, the first transceiver 2 is configured to estimate the variability in channel quality for the wireless communication link by calculating an autocorrelation for the channel quality estimates. With this approach, lower autocorrelation values indicate higher variability in channel quality and higher autocorrelation values indicate lower variability in channel quality.

In another embodiment, the first transceiver 2 is configured to estimate the variability in channel quality for the wireless communication link by measuring received signal strengths at two or more receive antennas and tracking over time an autocorrelation in signal strengths for the one or more antennas. Alternatively, the first transceiver 2 is configured to estimate the variability in channel quality for the wireless communication link by tracking over time ACK/NACK feedback from the second transceiver 4, which is receiving transmissions from the first transceiver 2 over the wireless communication link. The first transceiver 2 uses the ACK/NACK feedback to determine a relationship between reception error rates at the transceiver 4 and channel quality estimate age.

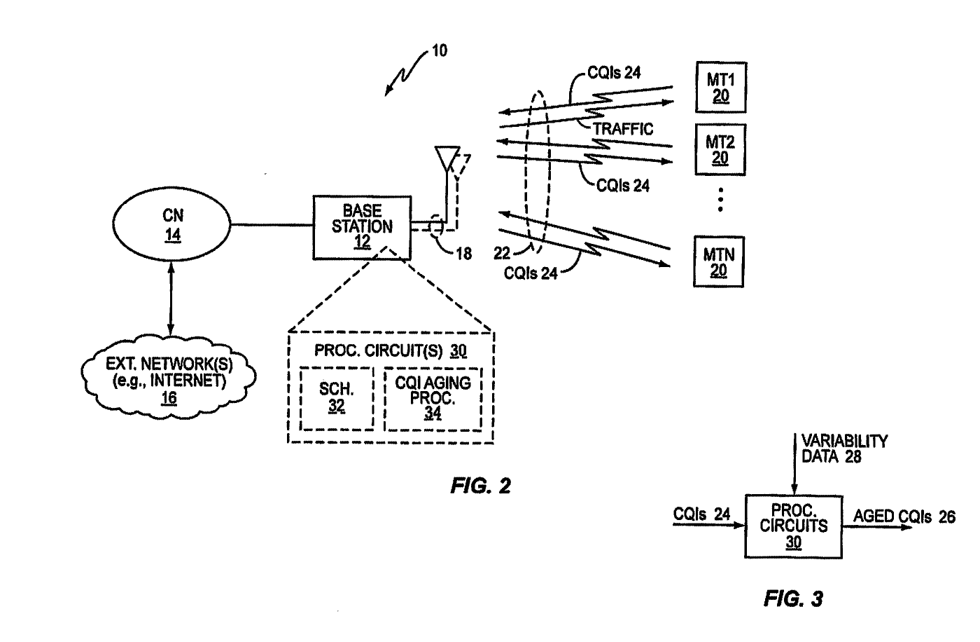

It may be helpful to turn from the general illustration of FIG. 1, to more specific embodiments. To that end, FIG. 2 partially illustrates a wireless communication network 10, including a wireless communication network base station 12 that is communicatively coupled to a core network (CN) 14. In turn, the core network 14 is communicatively coupled with one or more external networks 16, such as the Internet. The base station 12 includes one or more antennas 18 for wireless communication with a plurality of mobile terminals 20, e.g., MT1, MT2, . . . , MTN. By way of non-limiting example, the network 10 comprises a Long Term Evolution (LTE) network, and the base station 12 comprises an eNodeB configured for operation according to the air interface protocols of the LTE standards.

In operation, the base station 12 controls one or more transmission parameters used for transmitting to all or selected ones of the mobile terminals 20 on the illustrated communication links 22, based on channel quality feedback from the mobile terminals 20. More particularly, the base station 12, in one or more embodiments, is configured to control transmissions to the plurality of mobile terminals 20 based on aged channel quality indicators (CQIs) 24, where the “aging” applied to the CQIs from each mobile terminal 20 is functionally dependent on the variability in channel conditions for that mobile terminal 20. (In this regard, CQIs will be understood to be a form of channel quality estimates, and aged CQIs will be understood to be a form of aged channel quality estimates.)

Referring briefly to FIG. 3, one sees CQIs 24 incoming to the one or more processing circuits 30 of the base station 12, for a given one of the mobile terminals 20. Correspondingly, one sees that the processing circuits 30, which may include a scheduler 32 and a CQI aging processor 34 as shown in FIG. 2, output aged CQIs 26. The aged CQIs 26 are backed-off or discounted versions of the incoming CQIs 24. Notably, the amount of age-based compensation applied to the incoming CQIs 24 is a function of their ages and of the channel variability specifically associated with the mobile terminal 20 reporting the CQIs 24, as indicated by the variability data. Channel variability may be estimated directly from the incoming CQIs 24, or from some other type of variability data 28, input to the processing circuits 30. In at least one embodiment, the variability data 28 comprises per-antenna uplink signal strength measurement data, which is processed for estimation of channel variability based on the observed variance over time in uplink signal strengths at one or more base station antennas, for the given mobile terminal 20. That is, the variation in signal strength at each of one or more given antennas can be determined over time, and used as the basis for estimating the variability in channel quality. In any case, those skilled in the art will appreciate that aged CQIs 26 can be generated for each mobile terminal 20, based on aging the CQIs 24 received from that mobile terminal 20 according to the channel variability estimated for that mobile terminal 20.

Broadly, then, the processing circuits 30 within the base station 12 are configured to estimate a variability in channel quality for each mobile terminal 20, and to compute aged CQIs 26 for the mobile terminals 20, by adjusting the CQIs 24 received from each mobile terminal 20 according to an aging function that depends on channel quality indicator age and on the variability in channel quality estimated for the mobile terminal 20. Still further, the processing circuits 30 are configured to control transmissions to the mobile terminals 20 based on the aged CQIs 26. As non-limiting examples, the one or more processing circuits 30 are configured to control transmissions to the plurality of mobile terminals 20 based on the aged CQIs 26 by at performing at least one of the following control functions based on the aged CQIs 26: (1) selecting modulation and coding schemes; (2) selecting transmission rank; (3) selecting between open-loop or closed-loop multiple-input-multiple-output (MIMO) transmission modes; and (4) scheduling transmissions to the plurality of mobile terminals 20.

FIG. 4 illustrates the above base station processing in the form of an example method, depicted in logic flow diagram form. The base station 12 can be configured via hardware, software, or some combination of both, to implement the illustrated method. In at least one embodiment, the one or more processing circuits 30 are microprocessor-based circuits executing stored computer program instructions, held in a computer-readable medium within or accessible to the base station 12. For example, the base station 12 includes one or more disc drives or other permanent storage media, and dynamic RAM (DRAM) as operating memory into which program instructions and data are loaded for live processing.

In any case, the illustrated method “begins” with the base station 12 estimating a variability in channel quality for each of one or more mobile terminals 20 (Block 100). For example, the base station 12 may be an LTE base station providing scheduled downlink transmissions to a plurality of LTE mobile terminals. Processing continues with the base station 12 computing aged CQIs 26 for each such mobile terminal 20, according to an aging function that depends on CQI age and the variability in channel quality estimated for the mobile terminal 20 (Block 102). Further, processing continues with the base station 12 controlling transmissions to the one or more mobile terminals 20, based on the aged CQIs 26 (Block 104). As used in this context, the “age” of a given CQI 24 may be determined based on the delay between its generation at the reporting mobile terminal 20 and its use by the base station 12 in controlling transmissions to that mobile terminal 20.

Unlike conventional approaches to CQI compensation, which discount CQIs based on tracking retransmissions, or using purely time-based discounting, the base station 12 varies or otherwise adjusts the aging sensitivity of the CQIs 24 from each given mobile terminal 20, based on the variability in channel conditions estimated for that mobile terminal 20. This approach provides potentially significant gains in overall throughput, because the aging back-off applied to CQIs 24 from a given mobile terminal 20 that enjoys relatively stable channel conditions can be made less aggressive than that applied to CQIs 24 received from a mobile terminal 20 that is operating with greater variability in its channel conditions.

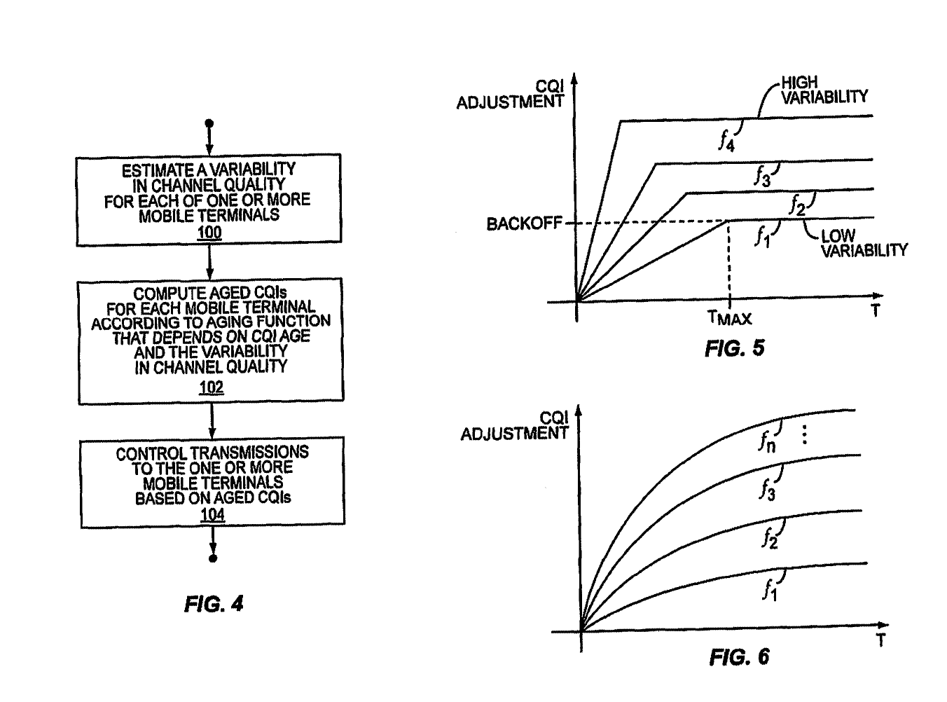

As a non-limiting example, FIG. 5 illustrates that the base station 12 may be configured to use a family of predefined aging functions ƒ₁-ƒ₄. With this approach, the particular function used to age the CQIs 24 from a given mobile terminal 20 is selected according to the channel variability estimated for the mobile terminal 20. For example, channel variability can be divided into a number of ranges, such as low, medium, high, and very high. With this approach, the particular one of the predefined functions aging functions ƒ₁-ƒₙ used to age the CQIs 24 from a given mobile terminal 20 is determined based on determining where the channel variability estimated for the mobile terminal 20 falls in terms of the channel variability ranges.

In the example of FIG. 5, the aging function ƒ₁ would be selected for aging the CQIs 24 from mobile terminals 20 that are estimated as having low variability in channel quality, while the CQIs 24 from mobile terminals 20 having medium or high variability would be aged using ƒ₂ or ƒ₃, respectively. One sees that these predefined functions are linear from a time t=0 out to a time t=Tₘₐₓ, and that the slope from 0 to Tmax determines the aggressiveness of the aging backoff applied to CQIs 24. (The CQI backoff may be measured in dBs or CQI units, for example, and may range from 0 dBs 1.5, 2, or more dBs, depending upon the particulars of the wireless communication network 10, and the data rates, etc., used by it.)

In any case, each of the predefined functions use a linear aging over a first time window, where the amount of back-off applied to CQIs 24 from a given mobile station 20 depends directly on the computed age of the CQIs, although the particular function to use for aging is still selected as a function of that mobile terminals' estimated channel variability. Beyond a certain age, Tₘₐₓ, each of the predefined aging functions ƒ₁-ƒ₄ takes on a constant value. However, the time value of Tₘₐₓ may be different for different aging functions. That is, each of the predefined functions can be characterized by its slope for its linear portion, and by the time Tₘₐₓ at which it transitions into a constant back-off value.

FIG. 6 illustrates another example set of predefined functions, ƒ₁-ƒₙ, which use non-linear aging curves that asymptotically approach a maximum back-off value. As with the predefined aging functions illustrated in FIG. 5, the base station processing circuits 30 age the CQIs 24 incoming from a particular mobile station 20 based on estimating the channel variability for that mobile station 20 and picking a corresponding one of the predefined aging curves to use for generating aged CQIs 26 from those incoming CQIs 24. Also as before, the processing circuits 30 are configured to pick more aggressive aging functions for those mobile stations 20 exhibiting higher channel variability, and pick less aggressive aging functions for those mobile stations 20 exhibiting lower channel variability.

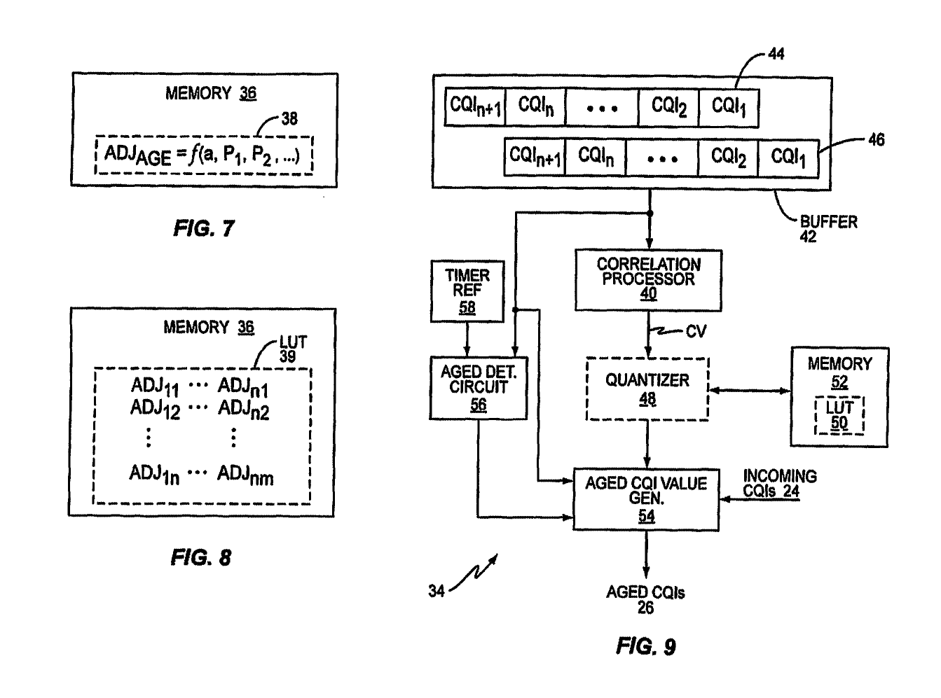

Broadly, then, in one or more embodiments, the processing circuits 30 are configured to compute the aged CQIs 26 for the mobile terminals 20 by, for each mobile terminal, selecting a particular aging function from among a predefined set of aging functions, based on the variability in channel quality estimated for the mobile terminal 20, and determining an adjustment value for a given CQI 24 received from the mobile terminal 20 according to its age and the selected aging function. In at least one such embodiment, the processing circuits 30 are configured to store parameterized functional expressions or tabulated look-up values representing the predefined set of aging functions. FIGS. 6 and 7 illustrate examples of these embodiments.

In FIG. 7, a memory 36 within the base station 12 stores a predefined aging function 38, ƒ(a, P₁, P₂ . . . ), which is used to determine the age-based adjustment ADJ_{AGE} to be applied to CQIs 24 from a given mobile terminal 20, to generate corresponding aged CQIs 26. The value ADJ_{AGE} may be expressed in dBs or CQI units, and it represents the amount of back-off applied to the CQIs 24 incoming from a given mobile terminal 20. Further, in the given parameterized functional expression, “a” represents the calculated age of a given CQI 24, and P₁, P₂, etc., represent a desired number of parameters, including an estimate of channel variability for the given mobile terminal 20. For example, the parameter P₁ represents the estimated channel variability, while P₂ represents a given communication mode or configuration of the mobile terminal 20. As one example, aging may be more or less aggressive depending on the particular mode of MIMO transmission being used to communicate with the given mobile terminal 20. For example, transmit diversity mitigates fading variations which results in less variability while spatial multiplexing suffers more from multipath fading variations resulting in more variability. Those skilled in the art will appreciate that the particular parameters used to tailor CQI aging for a given mobile terminal 20, in addition to the channel variability parameter, may be selected according to the transmission control particulars of the wireless network 10.

In FIG. 8, the memory 36 stores a look-up table (LUT) 39, which includes a plurality of CQI adjustment values, ADJ₁₁ . . . ADJₙ₁ in row 1, ADJ_{1,2} . . . ADJₙ₂ in row 2, and so on. The elements of LUT 39 thus represent different CQI back-off adjustments for different combinations of CQI age and corresponding channel variability. For example, each row in the LUT 39 corresponds to a different range or degree of channel variability, and each column corresponds to a different CQI age or age range. Thus, the processing circuits 30 are configured to age the CQIs 24 from a given mobile terminal 20 by indexing into the LUT 39 according to the age of each CQI 24 and the channel variability estimated for the mobile terminal 20.

In these or other embodiments, the one or more base station processing circuits 30 are configured to estimate the variability in channel quality for each mobile terminal 20 by correlating the CQIs 24 received from the mobile terminal 20. That is, each CQI 24 from a given mobile terminal 20, for a given reporting time or interval can be correlated with the CQIs 24 from that same mobile terminal 20, for a plurality of other reporting times. FIG. 9 illustrates an example implementation of the CQI aging processor 34 introduced in FIG. 2, wherein it includes a correlation processor 40 and a buffer 42. The buffer 42 buffers a set 44 of incoming CQIs 24 from a given mobile terminal 20, and buffers a time-offset or shifted set 46 of those CQIs 24. Those skilled in the art will appreciate that the buffer 42 holds CQI sets 44 and 46 for each mobile terminal 20 of interest, or that multiple such buffers are used. It will also be appreciated that the buffer 42 may be used to hold a running window of incoming CQIs 24, where the buffer depth and the reporting period(s) of the incoming CQIs 24 define the time window spanned by the buffer 42.

With the availability of CQIs 24 taken over a given window of time, the correlation processor 40 determines correlation values (CVs in the illustration) between the set 44 of CQIs 24 and the offset set 46 of CQIs. Alternatively, the correlation processor 40 simply uses offset indexing for the set 44 of CQIs 24, to determine the correlations between CQIs 24. Regardless, the correlation values are optionally passed to a quantizer 48, which quantizes the calculated correlation values, e.g., into low, medium, high, and very high ranges determined from a LUT 50 stored in a memory 52. Here, the LUT 50 provides mapping from the calculated correlation values into a quantized channel variability range.

The correlation values (quantized or un-quantized) are provided as input data to an aged CQI value generator 54, which also receives CQI age values for individual CQIs 24. This CQI age information may be determined, for example, by an age determining circuit 56, which uses a timing reference 58 for determining elapsed times between CQI measurement/reporting by the mobile terminals 20, and corresponding transmission control usage of those CQIs 24 at the base station 12. With the computed CQI ages and the channel variability estimates, the aged CQI value generator 54 receives incoming CQIs 24 (e.g., from the buffer 42), and applies an aging adjustment to them, to produce corresponding aged CQIs 26. The amount of aging-based backoff applied to the incoming CQIs 24 thus is a function of the channel variability estimated for the mobile terminal 20 that reported the CQIs 24. Those skilled in the art will appreciate that the same or duplicate circuitry processes the CQIs 24 from each mobile terminal 20 of interest, to produce aged CQIs 26 for each such mobile terminal 20.

As an alternative, the correlation processor 40 and buffer 42 may be implemented in each mobile terminal 20 of interest. Each such mobile terminal 20 is configured to report channel quality estimate variability. Further, it is possible to implement most or all aging processing in the mobile terminals 20, but, at least with respect to downlink transmissions, the mobile terminals 20 generally will not know actual base station scheduling and transmission times, and age determination thus can be based on average age estimates.

In another embodiment, the processing circuits 30 are configured to estimate the variability in channel quality for each mobile terminal 20 by calculating a correlation for the CQIs 24 received from the mobile terminal 20. That is, the CQI aging processor is configured to compute autocorrelation between the CQIs 24 received for each mobile terminal 20 of interest.

Higher autocorrelation values indicate lower variability in channel quality and lower autocorrelation values indicate higher variability in channel quality.

In yet another embodiment, the processing circuits 30 are configured to estimate the variability in channel quality for each mobile terminal 20 by measuring uplink signal strengths for the mobile terminal 20 and determining an autocorrelation in uplink signal strengths.

Alternatively, the processing circuits 30 are configured to estimate the variability in channel quality for a given mobile terminal 20 by tracking ACK/NACK feedback from the mobile terminal 20, to determine a relationship between reception error rates at the mobile terminal 20 and CQI age. For example, the base station 12 can be configured to “learn” the bit or block error rate for a given mobile terminal 20, based on ACK/NACK feedback from that mobile terminal 20, and, from that, to derive an estimate of channel variability for that mobile terminal 20.

In the same or other embodiments, the one or more base station processing circuits 30 are configured to associate different communication modes with different predefined values or degrees of variability in channel quality. In such embodiments, the processing circuits 30 estimate the channel variability—i.e., the variability in channel quality—for each mobile terminal 20 based at least in part on a current communication mode of the mobile terminal 20. For example, closed-loop MIMO is sensitive to mobile speed, because it aims at following multipath fading, while open-loop MIMO does not and average out multipath variations. For the same mobile terminal 20 at a given mobile speed, the closed-loop MIMO will result in a higher CQI variability than open-loop. Since it is possible to dynamically switch between open- and closed-loop it is an advantage to separate their variability estimates. Other general examples include these items: (1) frequency selective precoding gives higher variability than wideband precoding; (2) frequency selective CQI reporting gives higher variability than wideband CQI; (3) transmit diversity gives lower variability than spatial multiplexing; and (4) lower transmission rank (rank restriction) gives lower variability.

In the same or other embodiments, the one or more base station processing circuits 30 are configured to compute the aged CQIs 26 for the mobile terminals 20 by, for each mobile terminal 20, selecting a particular aging function from among a predefined set of aging functions, based on the variability in channel quality estimated for the mobile terminal 20, and determining an adjustment value for a given CQI 24 received from the mobile terminal 20 according to its age and the selected aging function. As previously noted, FIGS. 6 and 7 provide examples of predefined, stored aging functions and corresponding LUTs.

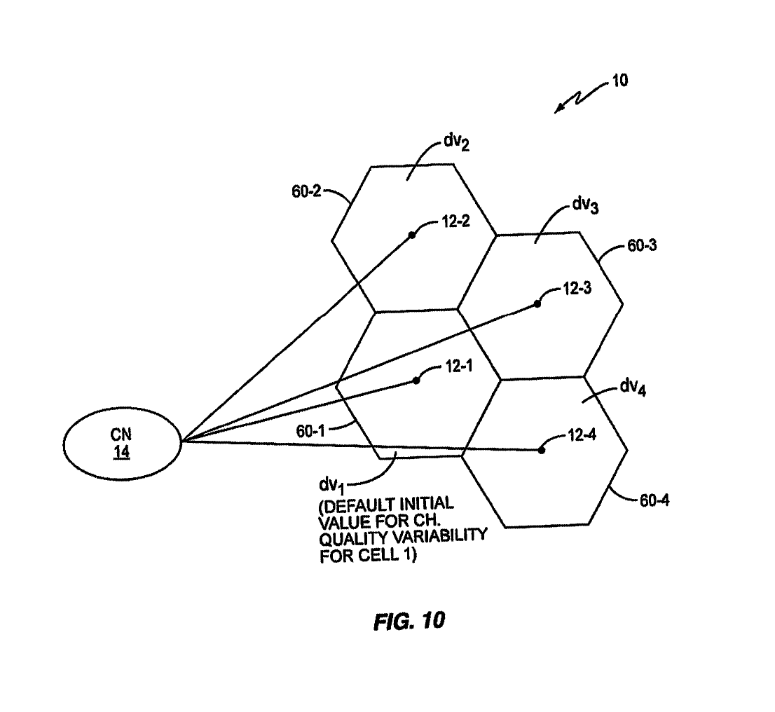

Additionally, the processing circuits in one or more embodiments are configured to estimate the variability in channel quality for each mobile terminal 20 by using a default value at least during an initialization period, wherein insufficient data is available for calculating an estimate of the variability in channel quality for the mobile terminal 20. FIG. 10 illustrates one example of such operation.

The illustration depicts the wireless communication network 10 as having a number of cells 60-1 through 60-4, each cell served by a corresponding base station 12-1 through 12-4. Each base station 12-1, 12-2, and so on, can be configured as the base station 12 introduced in FIG. 2. For convenience, the suffixes are omitted from the base station references, unless needed to distinguish between the cells 60-1 . . . 60-4.

Each base station 12 is configured with one or more default values to use as the estimate of channel quality variability for mobile terminals 20, in cases where there is insufficient data to generate an actual estimate, e.g., at call setup. For example, each base station 12 can be configured with a default value or values representative of historical averages or norms of channel quality variability for its corresponding cell 60. That is, the base station 12-1 may use a default value or values that have been empirically or analytically determined for the reception characteristics known or expected for cell 60-1. Further, in at least one embodiment, a given base station is loaded with a starting default value, and then it refines it over time, based on tracking historical values of actual estimated channel variability.

Also, different default values may be configured for different communication modes, etc. In any case, it should be understood that, with respect to the illustrated cells, base stations 12-1 through 12-4 can be configured respectively with default values “dv1” through “dv4.” With that arrangement, the base station 12-1 uses dv1 as a default estimate of channel variability for given mobile terminals 20, until sufficient data is available for making terminal-specific estimates; likewise, base station 12-2 uses dv2, and so on. Broadly, any given base station 12 can be configured such that its processing circuits 30 are, with respect to a given service area of the base station 12, configured to use a default value that is based on a known or expected variability in channel quality that is characteristic for the given service area. Thus, different default values can be used for different base station sectors or other service area divisions. Further, within any given sector or service area, different default values can be used for different communication modes.

Thus, with the preceding example discussions in mind, it will be appreciated that the base station 12 presented in this document provides a method and apparatus for transmission control—e.g., link adaptation—that takes the ages of the available channel quality measurements into account when doing link adaptation. But more particularly, the amount of aging back-off applied to given channel quality measurements from a given mobile terminal 20 depends on the variability in channel quality estimated for that mobile terminal 20. In an LTE embodiment, the ages of the terminal-reported CQIs 24 are known to the base station 12. That is, the LTE standards specify the CQI reporting delays (currently 4 ms is specified). At the transmission control instant at the base station 12—i.e., when transmission control is done based on a received report—the total measurement delay can be calculated as the sum of the reporting delay plus the time that has elapsed since report was received.

This overall aging may be understood by describing report generation and usage, according to the following generalized steps for an LTE implementation:
(1) a given mobile terminal 20 measures downlink signal quality at a given measurement time, tₘₑₐₛ, and correspondingly produces CQIₘₑₐₛ;
(2) the mobile terminal 20 reports its channel quality to the base station 12 by sending CQIₘₑₐₛ;
(3) the base station 12 receives CQIₘₑₐₛ, and time stamps it t_{cqirec}, to denote its time of receipt according to the base station's timing reference—notably, at this point, the age of CQIₘₑₐₛ is a known value, i.e., its age is the standard reporting time delay, dᵣₑₚ=t_{cqirec}−tₘₑₐₛ;
(4) the base station 12 schedules a downlink transmission to the mobile terminal 20 at a future time t_{sched};
(5) the base station 12 calculates a total delay time from measured quality to scheduled transmission as dₜₒₜ=dᵣₑₚ+t_{sched}−t_{cqirec},
(6) the base station 12 selects a CQI back-off value to use for adjusting CQIₘₑₐₛ as a function of the total delay and the estimated variability in channel quality, e.g., CQI_{offset}=ƒ(dₜₒₜ, var_{qual}); and
(7) the base station 12 uses the computed CQI_{offset} to compute an aged CQI value, CQI_{ADJ}=CQIₘₑₐₛ−CQI_{offset}, corresponding to CQIₘₑₐₛ, and then uses the aged CQI value, CQI_{ADJ}, for transmission control.

Those skilled in the art will appreciate that the above processing example, or variations of it, are carried out by the base station 12 on an ongoing basis, for CQIs 24 incoming from each of one or more mobile terminals 20. Further, similar processing can be performed for the uplink between a given mobile terminal 20 and the base station 12. That is, the base station 12 measures signal quality for uplink signals from the mobile terminal 20, and timestamps them for aging-related processing, such as for computing aged signal qualities with respect to scheduling uplink transmissions.

Also, it will be appreciated that the function ƒ(dₜₒₜ, var_{qual}) advantageously determines how aggressively the CQIs 24 reported from a given mobile terminal 20 are aged, to obtain aged CQIs 26 for making transmission control adjustments for that mobile terminal 20. FIGS. 4 and 5 provided examples of families of aging curves, where the particular aging curve to be used for aging the CQIs 24 from a given mobile terminal 20 is selected based on the corresponding estimate of channel quality variability for that mobile terminal 20. This approach provides different aging sensitivities for different mobility scenarios, which allows the base station 12 to strike a potentially much better balance between backing off CQI values as a function of age, for the sake of avoiding excessive retransmissions, and maximizing throughput on the downlink.

For example, high-mobility mobile stations 20 may be expected to exhibit higher channel quality variability than low-mobility mobile stations 20. According to the teachings presented in this document, the amount of age-based back-off applied to the CQIs 24 incoming from any particular mobile terminal 20 is made more aggressive or less aggressive, based on the corresponding estimate of channel quality variability made for that mobile terminal 20. In this manner, the CQIs 24 incoming from higher mobility mobile terminals 20 can be backed off more as a function of age, than those incoming from lower mobility mobile terminals 20. Of course, it may be that a given high-mobility mobile terminal 20 enjoys relatively low variability in its channel quality, despite its high mobility. In that case, the aging of its reported CQIs 24 would be made less aggressive.

By making the age-based back-off applied to CQIs 24 from a given mobile terminal 20 more or less aggressive as a function of the variability in channel quality estimated for that mobile terminal 20, the base station 12 obtains better utilization of the downlink resources through more accurate transmission control. That is, the base station 12 uses adjusted CQI values that in general are a more realistic representation of the channel conditions at the mobile terminal at the time transmission control is effected, e.g., at the time link adaptations are made for transmitting to the mobile terminal 20. This approach leads to higher bitrates and throughput, and lowers transmission latency, particularly for instances where mobile terminals 20 are operating with long channel quality reporting delays.

Of course, the present invention is not limited by the foregoing discussion, or by the associated drawings. Indeed, the present invention is limited only by the appended claims and their legal equivalents.

1-32. (canceled)

33. A method of computing aged channel quality estimates for use in controlling transmissions on a wireless communication link, said method comprising:
estimating a variability in channel quality for the wireless communication link; and
computing aged channel quality estimates corresponding to channel quality estimates determined for the wireless communication link by adjusting the value of each channel quality estimate by an amount that depends on the age of the channel quality estimate and on the variability in channel quality estimated for the wireless communication link.

34. The method of claim 33, wherein the wireless communication link comprises downlinks between a base station in a wireless communication network and a plurality of mobile terminals, the method further comprising controlling, at the base station, downlink transmissions to each mobile terminal based on the aged channel quality estimates computed for each mobile terminal.

35. The method of claim 34, further comprising receiving, at the base station for each mobile terminals, channel quality estimates from the mobile terminal on an ongoing basis, and correspondingly computing the aged channel quality estimates for that mobile terminal, or receiving, at the base station, the aged channel quality estimates as computed by the mobile terminal.

36. The method of claim 34, wherein controlling downlink transmissions to the mobile terminals based on the aged channel quality estimates comprises one or more of selecting modulation and coding schemes, selecting transmission rank, selecting between open-loop or closed-loop Multiple-Input-Multiple-Output (MIMO) transmission modes, selecting between wideband and frequency selective transmission precoding, selecting between transmit diversity and spatial multiplexing, and scheduling transmissions to the mobile terminals, based at least in part on the aged channel quality estimates.

37. The method of claim 34, further comprising, for a given service area of the wireless communication network, using a default value for the estimated variability in channel quality for each mobile terminal, at least during an initialization period, where the default value is based on a known or expected variability in channel quality that is characteristic for at least one of a given time of day and the given service area.

38. The method of claim 33, wherein the wireless communication link comprises uplinks between a base station in a wireless communication network and a plurality of mobile terminals, the method further comprising controlling, at the base station, uplink transmissions from the mobile terminals based on the aged channel quality estimates computed for the mobile terminals.

39. The method of claim 38, further comprising computing, at the base station for each mobile terminal, channel quality estimates based on uplink signals received from the mobile terminal, and correspondingly computing the aged channel quality estimates for that mobile terminal.

40. The method of claim 38, further comprising, for a given service area of the wireless communication network, using a default value for the estimated variability in channel quality for each mobile terminal, at least during an initialization period, where the default value is based on a known or expected variability in channel quality that is characteristic for at least one of a given time of day and the given service area.

41. The method of claim 33, wherein the wireless communication link comprises downlinks between a base station in a wireless communication network and a given number of mobile terminals, and wherein the base station is configured for different modes of Multiple-Input-Multiple-Output (MIMO) transmissions to the mobile terminals, the method further comprising associating different MIMO modes with different predefined values or degrees of variability in channel quality, such that estimating the variability in channel quality for each mobile terminal comprises estimating the variability in channel quality for the mobile terminal based at least in part on a current communication mode of the mobile terminal.

42. The method of claim 33, wherein computing aged channel quality estimates comprises selecting a particular aging function from among a predefined set of aging functions, and determining an adjustment value for a given channel quality estimate, according to the age of the channel quality estimate and the selected aging function.

43. The method of claim 42, further comprising storing parameterized functional expressions or tabulated look-up values representing the predefined set of aging functions.

44. The method of claim 33, wherein estimating the variability in channel quality comprises using a default value for the variability in channel quality at least during an initialization period, wherein insufficient data is available for calculating an estimate of the variability in channel quality during the initialization period.

45. The method of claim 33, further comprising determining the age of a given channel quality estimate based on calculating an elapsed time between a corresponding channel quality measurement on which the channel quality estimate is based and a forthcoming transmission time in which the corresponding aged channel quality estimate will be used for controlling transmissions on the wireless communication link.

46. The method of claim 33, wherein estimating the variability in channel quality for the wireless communication link comprises correlating the channel quality estimates over time, wherein higher correlation values indicate lower variability in channel quality and lower correlation values indicate higher variability in channel quality.

47. The method of claim 33, wherein estimating the variability in channel quality for the wireless communication link comprises calculating an autocorrelation for the channel quality estimates, wherein lower autocorrelation values indicate higher variability in channel quality and higher autocorrelation values indicate lower variability in channel quality.

48. The method of claim 33, wherein estimating the variability in channel quality for the wireless communication link comprises measuring received signal strengths at one or more receive antennas and tracking over time an autocorrelation in signal strengths for the one or more receive antennas.

49. The method of claim 33, wherein estimating the variability in channel quality for the wireless communication link comprises tracking over time ACK/NACK feedback from a wireless communication transceiver receiving transmissions over the wireless communication link, and determining a relationship between reception error rates at the wireless communication transceiver and channel quality estimate age.

50. A wireless communication transceiver configured to compute aged channel quality estimates for use in controlling transmissions on a wireless communication link, said wireless communication transceiver comprising one or more processing circuits configured to:
estimate a variability in channel quality for the wireless communication link; and
compute aged channel quality estimates corresponding to channel quality estimates determined for the wireless communication link, by adjusting the value of each channel quality estimate by an amount that depends on the age of the channel quality estimate and on the variability in channel quality estimated for the wireless communication link.

51. The wireless communication transceiver of claim 50, wherein the wireless communication transceiver comprises a base station in a wireless communication network and the wireless communication link comprises downlinks between the base station and a plurality of mobile terminals, and wherein the base station is configured to control downlink transmissions to each mobile terminal based on the aged channel quality estimates computed for each mobile terminal.

52. The wireless communication transceiver of claim 51, wherein, for each mobile terminal, the base station is further configured to receive channel quality estimates from the mobile terminal on an ongoing basis, and correspondingly compute the aged channel quality estimates for that mobile terminal, or receive the aged channel quality estimates as computed by the mobile terminal.

53. The wireless communication transceiver of claim 51, wherein the base station is configured to control downlink transmissions to the mobile terminals based on the aged channel quality estimates by one or more of selecting modulation and coding schemes, selecting transmission rank, selecting between open-loop or closed-loop Multiple-Input-Multiple-Output (MIMO) transmission modes, selecting between wideband and frequency selective transmission precoding, selecting between transmit diversity and spatial multiplexing, and scheduling transmissions to the mobile terminals, based at least in part on the aged channel quality estimates.

54. The wireless communication transceiver of claim 51, wherein the base station is further configured to use a default value for the estimated variability in channel quality for each mobile terminal, at least during an initialization period, where the default value is based on a known or expected variability in channel quality that is characteristic for at least one of a given time of day and a given service area of the wireless communication network that is associated with the base station.

55. The wireless communication transceiver of claim 50, wherein the wireless communication transceiver comprises a base station in a wireless communication network and the wireless communication link comprises uplinks between the base station and a plurality of mobile terminals, and wherein the base station is configured to control uplink transmissions from the mobile terminals based on the aged channel quality estimates computed for the mobile terminals.

56. The wireless communication transceiver of claim 55, wherein, for each mobile terminal, the base station is further configured to compute channel quality estimates based on uplink signals received from the mobile terminal, and correspondingly compute the aged channel quality estimates for that mobile terminal.

57. The wireless communication transceiver of claim 55, wherein the base station is further configured to use a default value for the estimated variability in channel quality for each mobile terminal, at least during an initialization period, where the default value is based on a known or expected variability in channel quality that is characteristic for at least one of a given time of day and a given service area of the wireless communication network that is associated with the base station.

58. The wireless communication transceiver of claim 50, wherein the wireless communication transceiver comprises a base station in a wireless communication network and the wireless communication link comprises downlinks between the base station and a given number of mobile terminals, wherein the base station is configured for different modes of Multiple-Input-Multiple-Output (MIMO) transmissions to the mobile terminals, and wherein the base station is further configured to associate different MIMO modes with different predefined values or degrees of variability in channel quality, such that the one or more processing circuits station estimate the variability in channel quality for each mobile terminal at least in part on a current communication mode of the mobile terminal.

59. The wireless communication transceiver of claim 50, wherein the one or more processing circuits are configured to compute the aged channel quality estimates by, for a given channel quality estimate, selecting a particular aging function from among a predefined set of aging functions, and determining an adjustment value for the channel quality estimate according to the age of the channel quality estimate and the selected aging function.

60. The wireless communication transceiver of claim 59, wherein the wireless communication transceiver is further configured to store parameterized functional expressions or tabulated look-up values representing the predefined set of aging functions.

61. The wireless communication transceiver of claim 50, wherein the one or more processing circuits are configured to estimate the variability in channel quality by using a default value for the variability in channel quality at least during an initialization period, wherein insufficient data is available for calculating an estimate of the variability in channel quality during the initialization period.

62. The wireless communication transceiver of claim 50, wherein the wireless communication transceiver is further configured to determine the age of a given channel quality estimate based on calculating an elapsed time between a corresponding channel quality measurement on which the channel quality estimate is based and a forthcoming transmission time in which the corresponding aged channel quality estimate will be used for controlling transmission on the wireless communication link.

63. The wireless communication transceiver of claim 50, wherein the one or more processing circuits are configured to estimate the variability in channel quality for the wireless communication link by correlating the channel quality estimates over time, wherein higher correlation values indicate lower variability in channel quality and lower correlation values indicate higher variability in channel quality.

64. The wireless communication transceiver of claim 50, wherein the one or more processing circuits are configured to estimate the variability in channel quality for the wireless communication link by calculating an autocorrelation for the channel quality estimates, wherein lower autocorrelation values indicate higher variability in channel quality and higher autocorrelation values indicate lower variability in channel quality.

65. The wireless communication transceiver of claim 50, wherein the one or more processing circuits are configured to estimate the variability in channel quality for the wireless communication link by measuring received signal strengths at one or more receive antennas and tracking over time an autocorrelation in signal strengths for the one or more receive antennas.

66. The wireless communication transceiver of claim 50, wherein the one or more processing circuits are configured to estimate the variability in channel quality for the wireless communication link by tracking over time ACK/NACK feedback from a second wireless communication transceiver receiving transmissions from the wireless communication transceiver over the wireless communication link, and determining a relationship between reception error rates at the second wireless communication transceiver and channel quality estimated age.
